(19) United States
(12) Patent Application Publication
(10) Pub. No.: US 2017/0094019 A1
(43) Pub. Date: Mar. 30, 2017

(54) Providing Access to Non-Obscured Content Items based on Triggering Events

(71) Applicant: Microsoft Technology Licensing, LLC, Redmond, WA (US)

(72) Inventors: Muzammil Ahmed, Seattle, WA (US); Saeed Jahed, Seattle, WA (US); Johnson Apacible, Mercer Island, WA (US); Hsiao-Lan Wang, Bellevue, WA (US); Siu Yu Cherie Quek, Redmond, WA (US)

(21) Appl. No.: 14/866,853

(22) Filed: Sep. 26, 2015

(51) Int. Cl. H04L 29/08; H04L 12/26

(52) U.S. Cl. CPC H04L 67/327; H04L 43/16

(57) ABSTRACT

A computer-implemented technique enables a creator-user to create an obscured version of a content item. The technique then posts the obscured version to a hosting environment. A monitoring system receives a requestor-user's request to obtain a non-obscured version of the content item. In response, the monitoring system determines whether a number of requestor-users who have made such a valid request exceeds a predetermined threshold value set by the creator-user. If so, the monitoring system provides access to at least part of the non-obscured version of the content item to all requestor-users who have made valid requests.

### BACKGROUND

Users can now easily create and post a large number of digital content items, such as pictures, videos, documents, etc. While this empowers creators of content items, it also raises challenges. A creator of content items may lack a clear understanding of whether the consumers who receive and presumably view the content items are truly interested in those content items. Without this knowledge, the creator may continue to send potentially unappealing content items to the consumers, without achieving a desired impact. This practice also disadvantages a consumer of the content items because he or she is potentially deluged with a large number of content items, only some of which may be of interest. Finally, the inefficient dissemination of content items potentially wastes computing and communication resources.

### SUMMARY

A computer-implemented technique is described herein for enabling a creator-user to create an obscured version of a content item, e.g., by obscuring at least part of a digital picture, video, document, etc. The technique then posts the obscured version to a hosting environment, such as a dedicated hosting site, a social networking site, etc. A monitoring system receives a requestor-user's request to obtain a non-obscured version of the content item. In response, the monitoring system determines whether a number of requestor-users who have made a valid request exceeds a predetermined threshold value set by the creator-user (or some other entity). If so, the monitoring system provides access to at least part of the non-obscured version of the content item to all requestor-users who have made valid requests for such access.

Different implementations of the technique can define what constitutes a valid request in different ways. In a first approach, the hosting environment presents the obscured version of the content item together with a command feature (such as a “let me see it” command button). The requestor-user generates a valid request to obtain a non-obscured version of the content item by activating the command feature (or performing some other command gesture). In a second approach, the hosting environment presents the obscured version of the content item together with an instruction to the requestor-user to appear at an identified geographic location or perform some other action. Here, the requestor-user manifests a valid request to see the non-obscured version by showing up at the identified geographic location or performing any other requested action.

The computer-implemented technique allows a creator-user to accurately gauge which users are interested in his or her content items. This knowledge enables the creator-user to subsequently more intelligently distribute content items to those recipients who are most likely to be interested in the content items. The creator-user benefits because he or she can increase exposure to content items in an efficient and targeted manner. The recipient of the content items benefits because he or she may be burdened with fewer irrelevant content items, making it easier to find and focus on relevant content items. The computing system which implements the technique benefits because the technique utilizes its computing and communication resources in an efficient manner.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a system for providing access to non-obscured versions of content items based on triggering events.

FIG. 2 shows one illustrative flow of operations within the system of FIG. 1.

FIGS. 3 and 4 show user interface functionality that enables a creator-user to produce an obscured version of a content item, and then to post that obscured version to a hosting environment.

FIG. 5 shows user interface functionality that allows a requestor-user to express interest in receiving a non-obscured version of the content item. FIG. 5 also shows the resultant non-obscured version that is provided to the requestor-user.

FIGS. 6-8 show three respective approaches by which a creator-user can identify a part of a content item to be obscured.

FIG. 9 shows user interface functionality that provides different instructions to the requestor-users, compared to the example of FIG. 5. Each instruction informs the requestor-user how he or she may make a valid request to obtain a non-obscured version of a content item.

FIG. 10 shows a process that represents one way of creating an obscured version of a content item, and then posting it to a hosting environment.

FIG. 11 shows a process that represents one way that a monitoring system can monitor requests by requestor-users to receive a non-obscured version of a content item.

FIG. 12 shows a more detailed instantiation of the process of FIG. 11.

FIG. 13 shows illustrative computing functionality that can be used to implement any aspect of the features shown in the foregoing drawings.

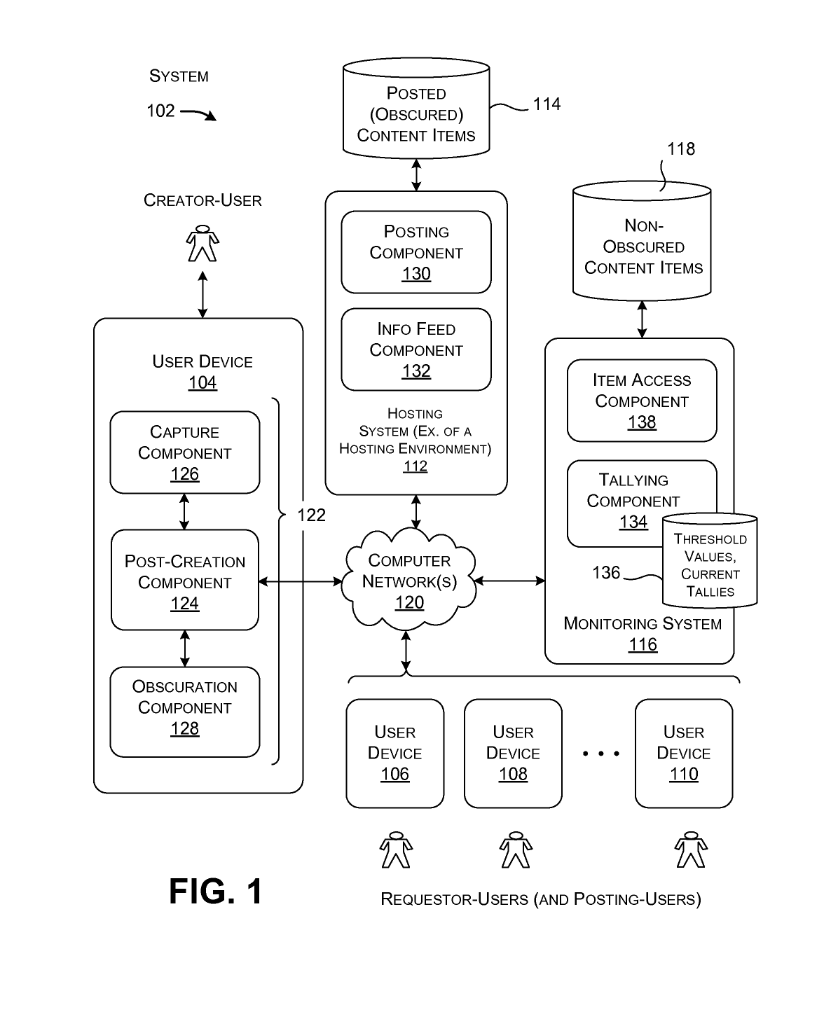

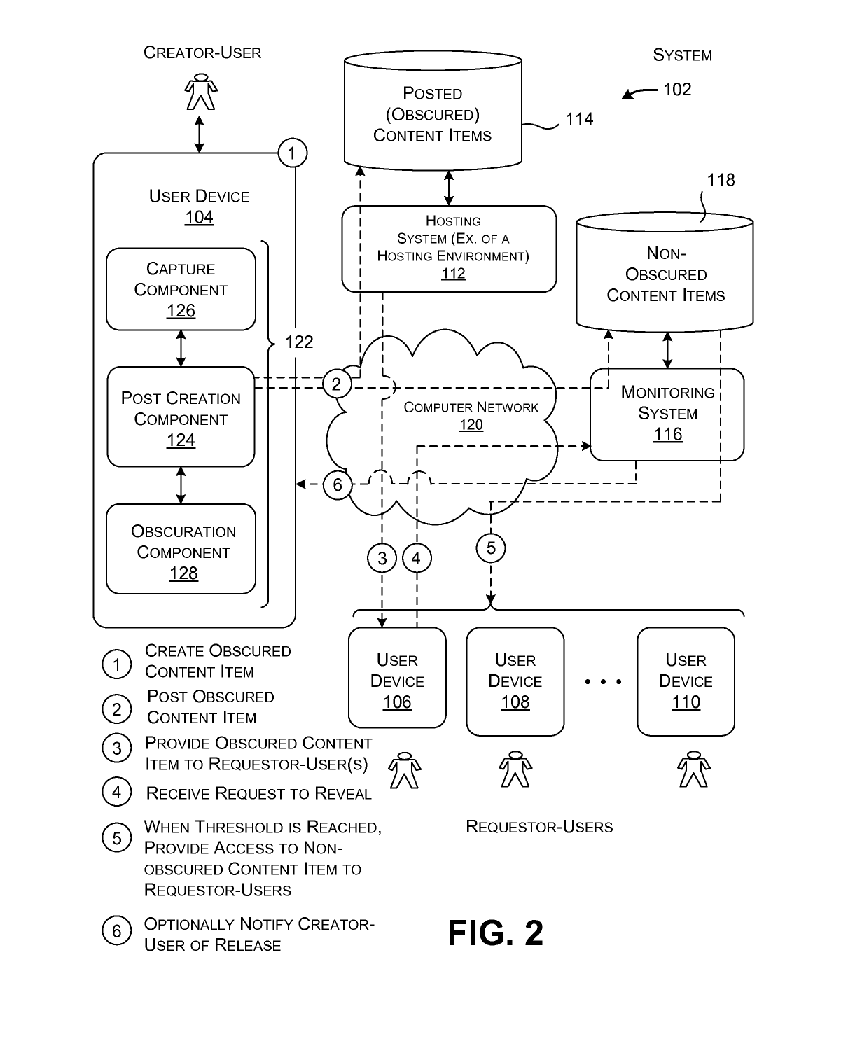

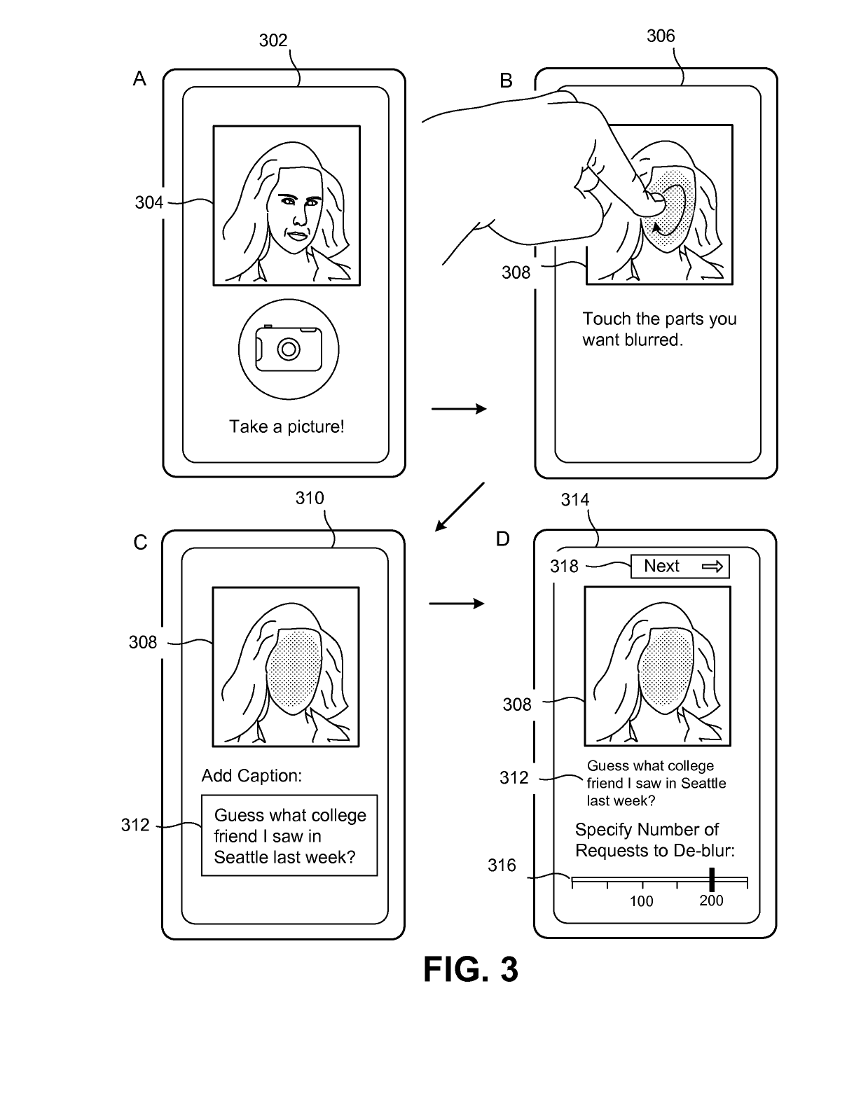

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computer-implemented system for providing selective access to non-obscured versions of content items based on triggering events. Section B sets forth illustrative methods which explain the operation of the system of Section A. And Section C describes illustrative computing functionality that can be used to implement any aspect of the features described in Sections A and B.

As a preliminary matter, some of the figures describe concepts in the context of one or more structural components, also referred to as functionality, modules, features, elements, etc. The various components shown in the figures can be implemented by various physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section C provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by various physical and tangible mechanisms, for instance, by software running on computer equipment, hardware (e.g., chip-implemented logic functionality), etc., and/or any combination thereof.

As to terminology, the phrase “configured to” encompasses various physical and tangible mechanisms for performing an identified operation. The mechanisms can be configured to perform an operation using, for instance, software running on computer equipment, hardware (e.g., chip-implemented logic functionality), etc., and/or any combination thereof.

The term “logic” encompasses various physical and tangible mechanisms for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

A.1. Overview

FIG. 1 shows a system 102 for allowing users to create obscured versions of content items and for allowing other users to request non-obscured counterpart versions of the content items. To facilitate explanation, any user who creates an obscured version of a content item is referred to as a creator-user. Any user who requests a non-obscured version of a content item is referred to as a requestor-user. Any user who submits a posting (or more generally, a “supplemental information item”) that is to be associated with an obscured version of a content item is referred to as a commenting-user. Any user may also serve two or more roles at different times; hence, a user may act as a creator-user in one circumstance, a requestor-user in another circumstance, and a commenting-user in another circumstance.

A content item may pertain to any piece of information of any nature. For example, a content item may include static image content, video content, text-bearing content, graphic content, audio content, etc., or any combination thereof. To facilitate explanation, this explanation will focus on the example in which the content item corresponds to a digital picture. Again, however, this example should be understood in the spirit of illustration, not limitation.

FIG. 1 shows a creator-user interacting with a user device 104. But more generally, any number of creator-users can interact with respective user devices. Plural requestor-users (and/or commenting-users) also interact with respective user devices (106, 108, . . . , 110). Any of the user devices (104, 106, 108, . . . , 110) may correspond to a computing device of any type, such as a desktop personal computing device, a game console device, a set-top box device, a laptop computing device, a tablet-type computing device, a smartphone, a wearable computing device, and so on.

The system 102 also includes one or more computer-implemented systems with which any user device may interact. For example, a hosting system 112 stores obscured version of content items in a data store 114. The hosting system 112, for example, may correspond to a network-accessible site that is dedicated to the task of storing and presenting obscured versions of content items (along, potentially, with non-obscured versions of other content items). In another case, the hosting system 112 may correspond to a general-purpose social networking site of any type.

A monitoring system 116 monitors requests by requestor-users to obtain non-obscured versions of the content items, which have been presented (in obscured form) to the requestor-users by the hosting system 112. The monitoring system 116 may also provide the requestor-users access to the non-obscured versions of the content items when certain triggering conditions are met (to be described below). To perform the last-mentioned task, in one implementation, the monitoring system 116 may store the non-obscured versions of the content items in a data store 118.

The hosting system 112 and the monitoring system 116 can each be implemented by one or more server computing devices and associated electronic equipment (e.g., routers, switches, load balancers, etc.). Further, note that FIG. 1 illustrates the hosting system 112 and the monitoring system 116 as two discrete physical systems. That configuration indeed represents one possible implementation of the system 102. In that case, the hosting system 112 may be administered by two respective entities or the same entity. In another case, the hosting system 112 and the monitoring system 116 may represent two instances of functionality implemented by the same physical system which are administrated by a single entity.

Also note that the hosting system 112 is just one specific example of a hosting environment. A hosting environment provides functionality for retaining and presenting obscured versions of content items. In another example, the hosting environment collectively represents user devices which store the obscured versions of the content items. In other words, instead of sending an obscured version of a content item to the hosting system 112, the creator-user's user device 104 can directly send the obscured version of the content item to the user devices (106, 108, . . . 110). The user devices (106, 108, . . . 110) store the obscured version of the content item in their respective local data stores. To nevertheless facilitate explanation, the description that follows will continue to emphasize the case in which the hosting environment corresponds to the hosting system 112 illustrated in FIG. 1.

A computer network 120 communicatively couples all of the above-identified components together. The computer network 120 may correspond to a local area network, a wide area network (e.g., the Internet), one or more dedicated point-to-point links, and so on, or any combination thereof.

The creator-user' user device 104 includes posting functionality 122. The posting functionality 122 creates a posting containing an obscured version of a content item, distributes the posting to a hosting environment, and optionally receives feedback (from the monitoring system 116) regarding the manner in which requestor-users have interacted with the posting. The posting functionality 122 contains a post-creation component 124, a capture component 126, and an obscuration component 128 which cooperate to perform the above operations.

The post-creation component 124 represents the main engine for defining the various features that make up a posting, in cooperation with the capture component 126 and the obscuration component 128. A posting refers to any package of information that contains the obscured version of the content item as one element thereof. In addition to managing the generation of the obscured version of the content item, the post-creation component 124 can also allow the creator-user to specify a threshold value. The threshold value specifies a number of requestor-users that are required to express interest in obtaining a non-obscured version of the content item, as a condition for allowing the requestor-users to access the non-obscured version of the content item. The post-creation component 124 can also include functionality for providing the posting (including the obscured version of the content item) to the hosting system 112.

In other implementations, the post-creation comment 124 can also allow the creator-user to specify condition information that specifies what constitutes a valid request to obtain the non-obscured version of the content item. In addition, or alternatively, the post-creation component 124 can allow the user to define plural obscured zones associated with a content item, and then to associate different triggering conditions with the different respective zones. Each triggering condition may be specified by an instance of condition information (which defines the nature of a valid request) and a threshold value (which defines a number of requests that are required to be received). Section A.3 provides further details regarding these implementations. However, at this juncture, assume that the creator-user provides a single threshold value which applies to the entire content item.

The capture component 126 produces an original content item, when commanded to do so by a post-creation component 124. For example, the capture component 126 may correspond to a camera for capturing a static image content item (e.g., a digital photo), a video camera for capturing a video content item, a microphone for capturing an audio content item, a word processing tool for creating a text-bearing content item, and so on, or any combination thereof. In addition, the capture component 126 can represent a tool for accessing a previously-created content item from any local and/or remote data store (with respect to the user device 106), when commanded to do so by the post-creation-component 124. For example, the capture component 126 can operate to retrieve an image content item from a local data store of the user device 104. In addition, or alternatively, the capture component 126 can access the image content item from some remote storage site.

The post-creation component 124 works in cooperation with the obscuration component 128 to produce an obscured version of the content item that has been captured by the capture component 126. The obscuration component 128 can perform this task in different ways. Consider the representative case of a static image content item. The obscuration component performs two roles to obscure such an item. First, it receives a selection of at least one part of the content item to be obscured. Second, it obscures those part(s).

As to the former operation, the obscuration component 128 can receive a manual selection from the creator-user which designates a part of the content item to be obscured. For example, the post-creation component 124 may display the non-obscured version of the content item on a touch-sensitive display screen of the user device 104. The obscuration component 128 can then invite the creator-user to touch a region of the non-obscured version of the content item that is to be obscured. Or the obscuration component 128 can invite the creator-user to trace the outer perimeter of a region to be obscured, e.g., using a stylus, pen, or other implement. In another case, the obscuration component 128 can receive a creator-user's specification of an object to be obscured in the content item. For example, the creator-user may select a “face” option from a dropdown menu or other control feature. The obscuration component 128 can then automatically recognize one or more faces (if any) in the content item using techniques known to those skilled in the art.

Having determined what part(s) of the content item to obscure, the obscuration component 128 can apply any techniques to obscure those part(s). With respect to an image content item, for instance, the obscuration component 128 can superimpose an image mask (such as a blacked-out rectangle or other shape) over each part of the content item to be obscured. Alternatively, or in addition, the obscuration component 128 can eliminate part(s) of the content item, thereby effectively producing a cropped version of the content item. Alternatively, or in addition, the obscuration component 128 can apply a Gaussian function to each part of the content item to be obscured, to thereby blur that part. Alternatively, or in addition, the obscuration component 128 can apply a pixelization process to each part of the content item to be obscured, and so on.

The obscuration component 128 can obscure other types of content items in different ways. For example, the obscuration component 128 can obscure each frame of a video content item in any of the ways described above. Alternatively, or in addition, the obscuration component 128 can select one or more frames of a video content item to produce an abbreviated version of the video content item. The selection of frames can be performed automatically (e.g., randomly) and/or manually (e.g., in response to an instruction from the creator-user).

The obscuration component 128 can obscure an audio content item by degrading any dimension of the sound quality of the audio content item, e.g., by distorting the audio content, removing one or more sound tracks from the content item, etc. Alternatively, or in addition, the obscuration component 128 can produce a low volume version of the audio content item. Alternatively, or in addition, the obscuration component 128 can produce an abbreviated version of the audio content item.

The obscuration component 128 can obscure a text-bearing content item by removing, blocking, and/or blurring portions of text (e.g., characters, words, paragraphs, etc.) in the text-bearing content item.

In some implementations, the obscuration produced by the obscuration component 128 is reversible. For example, the obscuration component 128 can scramble the pixels in a content item using a function (such as an encryption function) based on a key value. The monitoring system 116 can reverse the obscuration by using the same key to descramble the content item, in whole or in part. In another case, the obscuration component 128 can add a mask to part of the content item, while preserving the image content beneath the mask. The monitoring system 116 can reverse the obscuration by removing the mask to reveal the underlying image content, in whole or in part.

Now referring to the hosting system 112, a posting component 130 provides functionality that allows creator-users to store obscured versions of content items in the data store 114. For example, in a social networking site, the posting component 130 can provide interface functionality that allows a creator-user to post an obscured version of a content item to his or her own social networking page.

A requestor-user may interact with an obscured version of a content item posted by a creator-user in different ways. In one approach, the requestor-user may interact with the hosting system 112 by visiting a network-accessible site that stores an obscured version of the content item that has been posted by the creator-user. For example, the requestor-user may visit the creator-user's personal page which provides the obscured version of the content item. Or the requestor-user may visit a shared forum site which presents obscured versions of content items provided by two or more creator-users.

Alternatively, or in addition, an information feed component 132 can automatically notify the requestor-user when a creator-user has added a new obscured version of a content item to the hosting system 112. The notification may invite the requestor-user to obtain the obscured version of the content item (e.g., by a visiting a site which provides it). Or the notification may immediately show the obscured version of the content item to the requestor-user. In some implementations, each requestor-user may set up the information feed component 132 to choose the type(s) of content items that the requestor-user will receive via the feed, and from whom. For instance, the requestor-user may set up a feed by subscribing to certain types of content items, but not other types of content items.

Note that any user device operated by a commenting-user (for example, the user device 106) may also include a local instance of a capture component, a post-creation component, and an obscuration component (just like the user device 104). A commenting-user may interact with a local post-creation component (not shown) to create a supplemental information item, such as a comment, supplemental content item (e.g., an image, video, etc.), and so on. The commenting-user may then instruct the posting component 130 of the hosting system 112 to post the supplemental information item in association with a posting provided by a creator-user. For example, assume that a creator-user posts an obscured version of a digital photo to his or her own social networking page. A commenting-user can create a comment and instruct the posting component 130 to post that comment in association with the obscured version of the digital photo.

A commenting-user may also use a local obscuration component (not shown) to obscure any part of a supplemental information item, prior to posting it to the hosting system 112. For example, a commenting-user can use the obscuration component to block out, remove, or blur a portion of a comment. The commenting-user can then request the posting component 130 to post the obscured version of the comment in association with the obscured version of the content item produced by the creator-user. The commenting-user can also forward a non-obscured version of the comment to the monitoring system 116 for storage in the data store 118.

Now referring to the monitoring system 116, a tallying component 134 stores the above-described threshold value for each obscured version of a content item, as specified by an associated creator-user (and/or some other entity), in a data store 136. To repeat, the threshold value indicates a number of requestor-users that are required before the monitoring system 116 allows the requestor-users to gain access to a corresponding non-obscured content item. For each content item, the tallying component 134 also stores a current number of requestor-users who have currently requested access to the non-obscured version of the content item in the data store 136. Finally, the tallying component 134 determines whether the current number of requestor-users satisfies the threshold value, e.g., by exceeding the threshold value.

An item access component 138 grants access to a non-obscured content item to requestor-users, assuming that the tallying component 134 indicates that the required number of requestor-users have requested access to the non-obscured content item. The item access component 138 can grant access in different ways. In one technique, the item access component 138 can first send a notification message to each requestor-user that notifies the requestor-user that the non-obscured version is currently available. The notification message may optionally include a link or other command feature. A requestor-user may activate the link to initiate obtaining access to the non-obscured version of the content item. More specifically, upon activation of the link, the item access component 138 can retrieve the non-obscured version from the data store 118 and send it to the requestor-user through any channel, e.g., via an Email message, etc. Or the item access component 138 may provide access to the non-obscured version of the content item stored in the data store 118 without actually downloading a copy of the non-obscured version to the requestor-user for local storage by the requestor-user's user device. In another case, the item access component 138 can immediately provide access to the non-obscured version to one or more requestor-users, e.g., by sending an Email message to the requestor-users which provides the non-obscured version, that is, without first sending a notification message to those users.

In another case, the item access component 138 can provide a decryption key or the like to a requestor-user. The user device of the requestor-user uses the decryption key to decrypt an obscured version of a content item provided in the data store 118, to thereby obtain a non-obscured version of the content item (e.g., by descrambling the obscured version of the content item). In another case, the requestor-user's user device already stores an obscured version of the content item in a local data store. Here, the requestor-user's user device uses the decryption key to remove the obscuration from the locally stored content item. Still other techniques can be used for providing access to a non-obscured version of a content item.

The term “decryption key” is to be liberally construed herein. In one case, the decryption key may correspond to a formal cryptographic code, such as a code provided in accordance with the Advanced Encryption Standard (AES). In another case, the decryption key may correspond to any information (e.g., a password code) that allows the requestor-user's device to remove a blocking mask associated with the content item (for instance).

Moreover, the item access component 138 can provide access to non-obscured versions of supplemental information items (e.g., comments) provided by respective commenting-users. For example, when a threshold value is satisfied for a particular obscured version of a content item, the item access component 138 reveals both the non-obscured version of that content item and the non-obscured version of any supplemental information item that is associated with the content item (which was formerly obscured by a commenting-user).

The above-described distribution of functions among components is set forth in the spirit of illustration, not limitation. Other implementations can distribute functions among components of FIG. 1 in other ways. For example, in the implementation illustrated in FIG. 1, the post-creation component 124 and the obscuration component 128 represent functionality provided by the local user device 104. For example, the post-creation component 124 and the obscuration component 128 may form parts of a downloadable application that is stored by the user device 104. But in another case, a remote system (with respect to the user device 104) can implement the post-creation component 124 and/or the obscuration component 128, or parts thereof, e.g., in the form of a web application or the like. In this implementation, the user can upload the non-obscured version of the content item to the remote system and then use the resources of the remote system to operate on the content item in the manner described above.

FIG. 2 shows one illustrative flow of operations in the system 102 of FIG. 1. In operation (1), the posting functionality 122, under the direction of a creator-user, creates a posting that contains an obscured version of the content item. In operation (2), the posting functionality 122, under direction of the creator-user, submits the posting to the hosting system 112 for storage in the data store 114. The posting functionality 122 can also forward a non-obscured version of the content item to the monitoring system 116 for storage in the data store 118, along with a threshold value (and condition information, if provided). The threshold value specifies a number of requestor-users that are required in order to trigger the release of the non-obscured version of the content item. The condition information specifies what constitutes a valid request to obtain the non-obscured version.

In operation (3), a requestor-user uses a user device 106 to view the obscured version of the content item. For example, the requestor-user can visit a page of the creator-user that provides the posting created by the creator-user, which, in turn, includes the obscured version of the content item. The requestor-user may alternatively receive the posting in an information feed provided by the information feed component 132.

In operation (4), the requestor-user, using user device 106, then makes a request to the monitoring system 116 to obtain a non-obscured version of the content item. For example, the requestor-user may activate a “let me see it” command button or the like provided by the posting. Or the requestor-user may perform a prescribed “let me see it” gesture, such as by shaking the user device 106. Upon receipt of the message from the user device 106, the monitoring system 116 determines whether the request is valid, and then updates a count of the number of requestor-users who have made a valid request to obtain a non-obscured version of the content item under consideration.

The monitoring system 116 then compares this updated count with the threshold value. If the count satisfies the threshold value, then, in operation (5), the monitoring system 116 grants access to the non-obscured version of the content item to all requestor-users who have requested access. Assume, for example, that at least the three requestor-users shown in FIG. 2 have made valid requests to access to the non-obscured version of the content item. The monitoring system 116 can therefore send the non-obscured version to all three user devices (106, 108, 110), or otherwise provide access to the non-obscured version to all three user devices (106, 108, 110) using any of the other techniques described above. The monitoring system 116 can also provide access to non-obscured versions of any supplement information item(s) (e.g., comments) that are associated with the main content item.

In another scenario (not represented by FIG. 2), the posting functionality component 122 can directly send the obscured version of the content item to all of the requestor-users' user devices (106, 108, . . . 110). Each requestor-user's user device can forward a message to the monitoring system 116, notifying it when the requestor-user has made a request to obtain a non-obscured version of the content item. The monitoring system 116 can grant access to the non-obscured version by sending the non-obscured version to all requestor-users. Alternatively, the monitoring system 116 can provide a decryption key which allows the requestor-users' user devices to remove the obscuration in the obscured version of the content item they already have.

In optional operation (6), the monitoring system 116 can also notify the creator-user (via the user device 104) when the monitoring system 116 has released the non-obscured version of the content item to the requestor-users. Based on notification, the creator-user learns of whether the posted content item appealed to the target group of recipients to which it was offered. For example, assume that the creator-user sends an obscured version of the content item to his work colleagues. If the collective interest in the content item results in the quick revelation of its obscured content, then the creator-user now knows that the content item was popular among the target group. The monitoring system 116 can also optionally notify the creator-user of the identities of the requestor-users, and/or can notify the creator-user of the general demographic characteristics of the requestor-users (e.g., by providing any type of chart that shows demographic information). Generally, this reported information effectively informs the creator-user of the characteristics of the group of people who were sufficiently interested in the obscured version of the content item to make a request to see its non-obscured counterpart.

As another optional feature, the monitoring system 116 can foster interaction among requestor-users. For example, although not shown in FIG. 2, the monitoring system 116 can notify each requestor-user of the existence of other requestor-users who have made the same request for a content item under consideration. For example, if 200 people have made requests to see an obscured version of a content item, the monitoring system 116 can send any type of electronic message to the entire group of requestor-users which identifies the members of the group, and/or which identifies the general makeup of the group (e.g., by providing a chart of any type that reveals demographic information). In addition, or alternatively, the monitoring system 116 can invite the group of requestor-users to participate in a group discussion (e.g., a group text-based or video-based chat session), and so on. This functionality may provide an opportunity to bring people with similar interests together for social interaction. The monitoring system 116 can allow requestor-users to explicitly opt in to (and out of) any of any of the reporting functionality described above, to thereby honor the privacy-related expectations and preferences of individual requestor-users.

Although not shown in FIG. 2, the system 102 can also allow any creator-user to revoke a posting that has been created. The hosting system 112 may respond by deleting the posting from the data store 114. This event has the effect of terminating the opportunity of the requestor-users to interact with the posting and make requests to obtain a non-obscured version of the content item. In other cases, a creator-user may provide instructions which cause the system 102 to immediately release the non-obscured version of the content item without the triggering condition associated with the content item having been reached. In addition, the system 102 can allow any commenting-user (and/or the creator-user) to delete a supplemental information item that has been added to a creator-user's main posting.

Overall, the system 102 may confer one or more benefits to one or more entities associated with the system 102. From the standpoint of the creator-user, the system 102 provides feedback to the creator user that identifies a subset of requestor-users who are interested in each content item that he or she posts to the hosting system 112. The creator-user may leverage this knowledge by subsequently sending additional content items to certain respective individuals who may have the greatest interest in those items. By doing so, the creator-user can create enhanced exposure to his or her content items in an efficient manner. For example, the creator-user may discover that most of the requestor-users who requested non-obscured access to a picture of the creator-user's recent trip to Florida were the creator-user's college friends. Armed with this knowledge, the creator-user may be subsequently more inclined to send content items pertaining to Florida to that group.

In addition, an obscured version of a content item may be particularly enticing to requestor-users. The creator-user can leverage this fact by selectively obscuring those content items for which the content-user wishes to draw heightened interest. In other words, the system 102 provides an effective technique by which the creator-user can direct a recipient's focus of attention to certain content items within a potentially large collection of content items.

From the standpoint of the requestor-user, the system 102 provides a mechanism by which he or she can express interest in certain content items, but not others. Over time, the requestor-user may find that he or she receives an increasingly relevant stream of content items from creator-users, as the creator-users gain knowledge of the requestor-user's interests. This system behavior, in turn, allows the requestor-user to more efficiently interact with content items, e.g., by reducing the number of uninteresting content items which clutter the requestor-user's user interface presentation at any given time.

Moreover, the system 102 first stokes the requestor-user's interest in an obscured version of a content item through intrigue and anticipation, followed by providing a satisfying sense of closure upon providing the non-obscured version of a content item. In other words, the system 102 builds aesthetic tension and then releases it. In addition to the efficiency-related benefits set forth above, many requestor-users may simply enjoy such a psychological experience.

The system 102 also makes efficient use of computing and communication resources. For instance, as noted above, the creator-user can leverage the system 102 to provide content items to selected requestor-users who may be interested in these items, rather than indiscriminately flooding a larger population of requestor-users with content items. The reduced flow of information and messages reduces the consumption of computing and communication resources in the system 102.

Finally, in those implementations of the system 102 that use decryption keys, a creator-user can effectively control the dissemination of content items. This helps protect the privacy of potentially sensitive items.

A.2. Example

FIG. 3 shows user interface presentations that allow a creator-user to produce an obscured version of a content item, and then post it to the hosting system 112. In one implementation, the user device 104 produces the user interface presentations shown in FIG. 3. But as noted above, any other component(s) can alternatively, or in addition, produce the user interface presentations shown in FIG. 3.

In state A, the posting functionality 122 provides a user interface presentation 302 that invites the creator-user to capture an image content item. In other cases, the posting functionality 122 can also allow the creator-user to produce any other type of content item. In response to an instruction by the creator-user, the capture component 126 (which corresponds to a camera) takes a non-obscured (original) image content item 304.

In state B, the posting functionality 122 provides a user interface presentation 306 that invites the creator-user to obscure a part of the original content item, to produce an obscured version of the content item 308. In this scenario, the posting functionality 122 displays the non-obscured version of the content item 304 on a touch-sensitive display surface of the user device 104. The creator-user takes a finger and rubs it over the part(s) of the content item 304 that he or she wishes to obscure. The obscuration component 128 detects the part(s) of the touch-sensitive surface that the creator-user is touching, and detects the corresponding portions of the content item 304 that the user wishes to obscure. The obscuration component 128 can perform the actual operation of obscuration in different ways, e.g., by applying a Gaussian filter, by performing pixelization, by superimposing one or more masking images onto the content item, etc.

In state C, the posting functionality 122 provides a user interface presentation 310 that invites the creator-user to add an optional caption 312. Here, the creator-user adds the caption, “Guess what college friend I saw in Seattle last week?” The caption 312, along with the obscured version of the content item 308 itself, constitutes a posting. That posting is intended to entice requestor-users to engage the content item.

In state D, the posting functionality 122 provides a user interface presentation 314 that invites the creator-user to specify a number of requestor-users that are required in order for the monitoring system 116 to reveal the non-obscured content item 304. Here, the user interface presentation 314 provides a slide bar control feature 316. The creator-user manipulates the control feature 316 to set the threshold value to two hundred people. In other cases, the system 102 assigns a system default threshold value, rather than allowing the creator-user to manually select the threshold value. In other cases, the system 102 assigns a user-selected default threshold value, based on a threshold value that the creator user has previously defined and stored. In other cases, the system 102 assigns a default threshold value only if the creator-user does not manually select the threshold value. In still other cases (described in Subsection A.3)), the system 102 allows a creator-user to select plural threshold values and/or instances of condition information for different respective zones of the obscured version of the content item 308. In any event, the creator-user may activate a “next” command feature 318 when he or she is finished interacting with the user interface presentation 314.

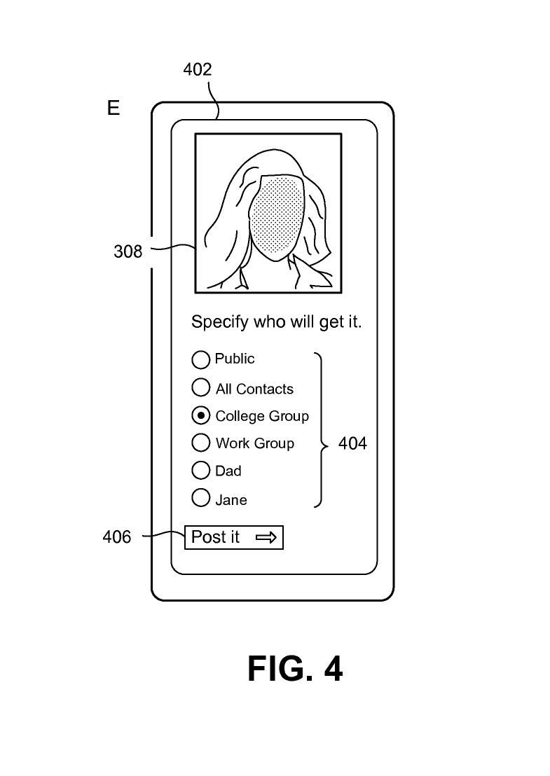

Advancing to FIG. 4, in state E, the posting functionality 122 provides a user interface presentation 402 that invites the creator-user to specify the target audience of the posting. For example, the user interface presentation 402 provides a list 404 of possible recipients. The posting functionality 122 may populate the list 404 of recipients based on contact information maintained by the creator-user and/or based on any other consideration(s). As one option, the list 404 invites the creator-user to send the posting to the general public without restriction. As another option, the list 404 invites the creator-user to send the posting to particular groups, such as a group composed of the creator-user's college friends. As another option, the list 404 invites the creator-user to send the posting to specific individuals, and so on.

The creator-user can select any one or more these options and then activate a “post it” command feature 406. In response, the posting functionality 122 posts the obscured version of the posting (including the content item 308 and the caption 312) to the hosting system 112 (or to some other hosting environment). The posting functionality 122 may also forward the non-obscured version of the content item 304 and the threshold value to the monitoring system 116 for storage thereat.

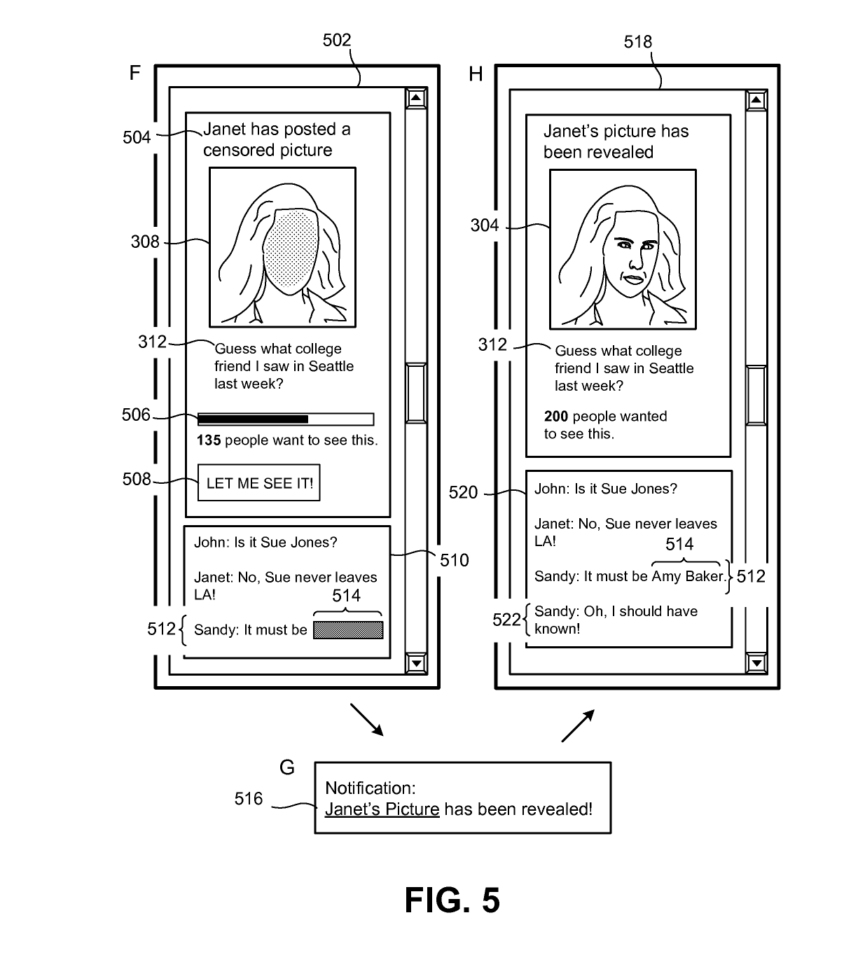

FIG. 5 shows, in state F, a user interface presentation 502 that is presented by the hosting system 112 and/or by a requestor-user's user device (e.g., user device 106). The user interface presentation 502 can show the obscured version of the content item 308, along with the caption 312. The user interface presentation 502 may also include a message 504 that informs the requestor-user that the creator-user (“Janet”) has posted a censored picture. The user interface presentation 502 can optionally also include a progress-display item 506 which informs the requestor-user how many people have made requests to receive the non-obscured version of the content item 304, and how many requests are still needed to satisfy the threshold value. Here, the progress-display item 506 is a thermometer-type graphic feature. The user interface presentation 502 also displays the current number of requestor-users in numeric form (here, it is 135 users).

The user interface presentation 502 can also provide a command feature 508 that allows the current requestor-user to make a request to obtain the non-obscured version of the content item. Here, the command feature 508 is a command button having the label “let me see it!” But the system 102 can alternatively allow the user to make a request through some other type of graphical control feature, and/or by issuing a voice command, and/or by making a prescribed gesture (e.g., by shaking the user device 106, tapping on the obscured portion of the content item as presented by a touch-sensitive display screen, etc.), and so on.

The user interface presentation 502 also presents a collection of supplemental information items 510 added by respective commenting-users. These supplemental information items 510 correspond to text-bearing postings added by the commenting-users, but any supplemental item can, more generally, include any kind(s) of content (including image content, video content, etc.). Note that the bottom-most supplemental information item 512 is partially obscured. In other words, the terminal words 514 in that supplemental information item 512 have been blacked out. A commenting-user achieves this effect using a local instantiation of a post-creation component and an obscuration component in the manner described above, e.g., by touching the terminal words 514 as presented on a touch-sensitive display screen of a user device. The commenting-user then posts the obscured supplemental information item 512 to the hosting system 112, for association with the obscured version of the content item 308.

In state G, assume that the monitoring system 116 concludes that a sufficient number (two hundred) of requestor-users have now requested access to the non-obscured version of the content item 304. In response, the monitoring system 116 forwards a notification 516 to each of the 200 requestor-users who has made a request for the non-obscured version of the content item 304. The notification 516 may include a hyperlink or other command feature. In this non-limiting case, the monitoring system 116 provides a requestor-user access to the non-obscured version of the content item 304 when the requestor-user activates the hyperlink.

Alternatively, the monitoring system 116 can directly transmit the non-obscured version of the content item 308 to each requestor-user, e.g., via Email or some other transmission mechanism. Alternatively, the monitoring system 116 can forward a decryption key or the like to each requestor-user's user device, which allows the user device to access the non-obscured version of the content item, which may be stored locally by the user device or remotely by the hosting system 112. In other words, the requestor-user's user device can use the decryption key to descramble the obscured version of the content item or otherwise unlock the non-obscured version of the content item, which has the end result of removing the obscuration from the content item.

Assume that the requestor-user that receives the notification 516 activates the hyperlink associated with the notification 516. In response, the monitoring system 116 provides the requestor-user access to the non-obscured version of the content item 304 in any of the ways described above. More specifically, the monitoring system 116 may provide access to a user interface presentation 518. The user interface presentation 518 provides the non-obscured version of the content item 304, the caption 312, and an updated collection of supplemental information items 520. Note that the previously-obscured supplemental information item 512 is now displayed without obscuration, to reveal the terminal words 514 (“Amy Baker”). Following the revelation of the non-obscured version of the content item 304, further note that a commenting-user has added a bottom-most supplemental information item 522.

A.3. Illustrative Variations

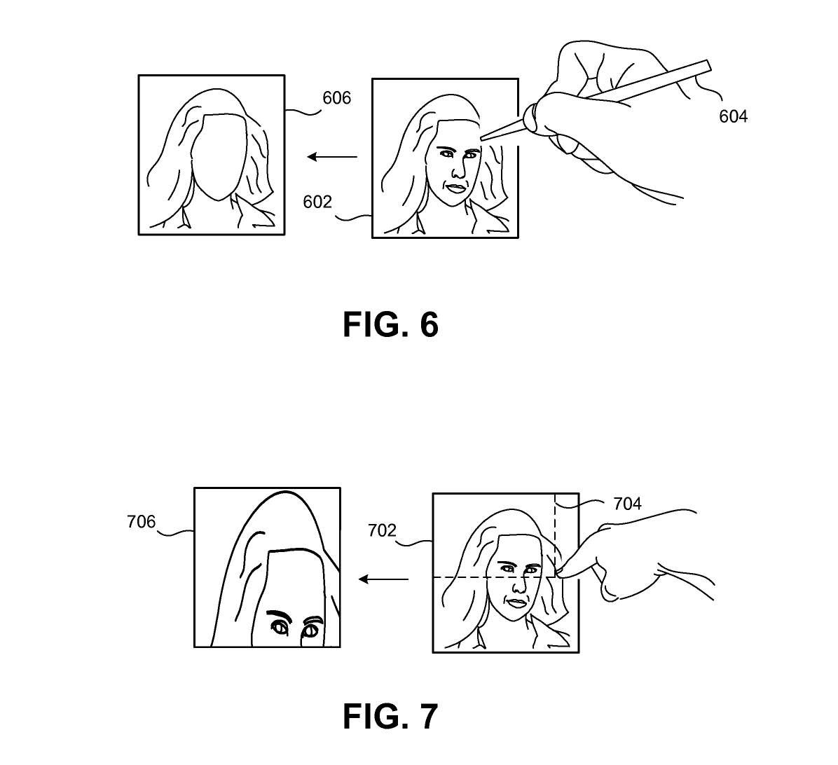

FIG. 6 show an alternative way in which the obscuration component 128 (in cooperation with the post-creation component 124) can interact with the creator-user to designate a portion of a non-obscured version of a content item 602 to be obscured. Here, the obscuration component 128 invites the creator-user to trace the outer perimeter of a region in the non-obscured version of the content item 602 with a stylus 604 or any other implement. In response to the completion of this tracing operation, the obscuration component 128 obscures the region enclosed by the outer perimeter, to produce an obscured version of the content item 606. Here, the user has traced the border of a person's face that appears in the non-obscured version of the content item 602; thus, the obscuration component 128 obscures the face of the person.

In the implementation of FIG. 7, the obscuration component 128 invites the creator-user to designate a portion of a non-obscured version of a content item 702. For example, the creator-user may use a finger (or tool) to specify a perimeter 704 of a region to be retained in an obscured version of the content item, e.g., by executing a drag-out gesture. In response, the obscuration component 128 produces an obscured (cropped) version of the content item 706.

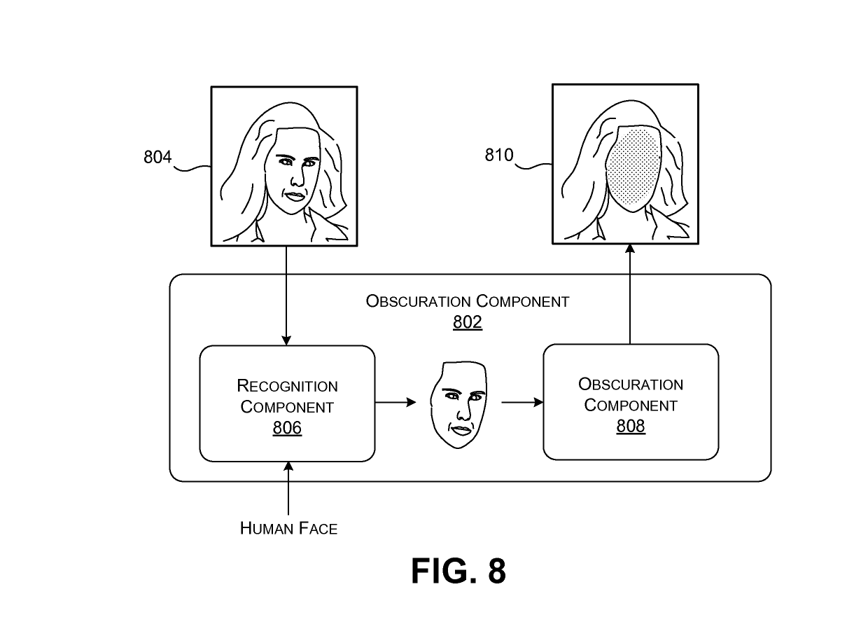

In the implementation of FIG. 8, an obscuration component 802 automatically recognizes an object within a non-obscured version of a content item 804. The user may specify the nature of the object, such as, in the scenario of FIG. 8, by instructing the obscuration component 802 to obscure any human faces in the non-obscured version of the content item 804. In response, a recognition component 806 uses known image recognition techniques to detect the object of interest in the non-obscured version of the content item 804. Generally, the recognition techniques may entail extracting features from the content item 804 and then using the features to classify different parts of the content item 804, e.g., in one case, using a machine-trained classifier. An obscuration component 808 then obscures the recognized object(s) (e.g., a human face) to produce an obscured version of the content item 810. The obscuration component 802 can obscure a video content item by using the same technique described above to each frame of the video content item.

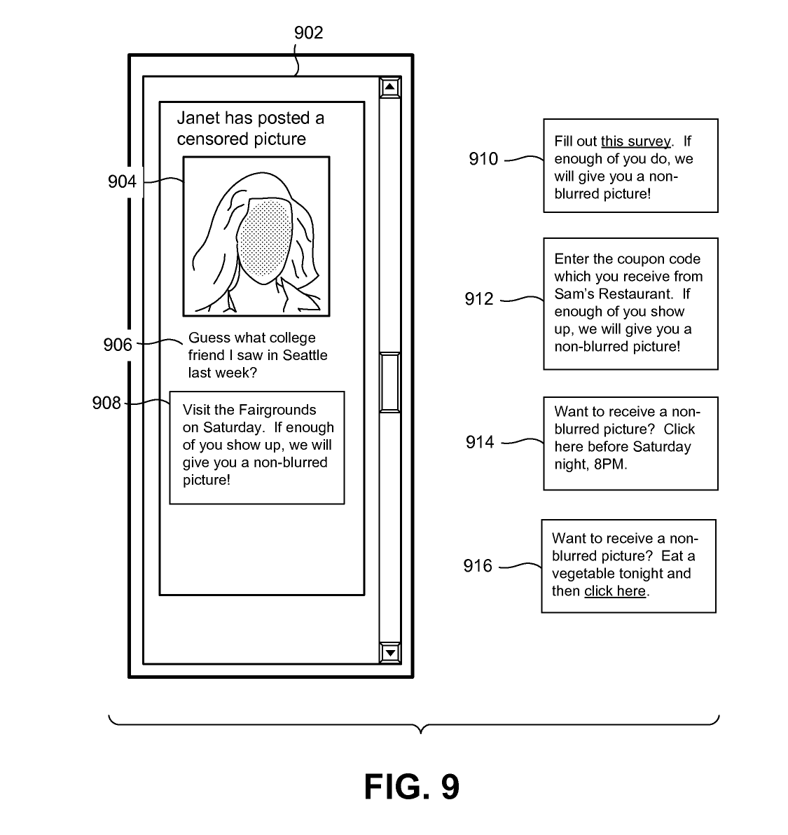

FIG. 9 shows another user interface presentation 902 provided by the hosting system 112. The user interface presentation 902 includes an obscured version of a content item 904 and a corresponding caption 906. The user interface presentation 902 also presents an instruction 908 which instructs the person viewing the user interface presentation 902 (i.e., the requestor-user) to visit a specified geographical location within a particular timeframe. It further informs the requestor-user that if enough requestor-users visit the geographic location, the monitoring system 116 will remove the obscured portion of the content item. The geographic location can have any spatial scope. For instance, it may correspond to a city, a neighborhood, an outdoor site (e.g., a park, golf course, etc.), an establishment (e.g., a retail store, etc.), and so on.

Assume that a group of n requestor-users do visit the specified geographic location within the predetermined timeframe. The monitoring system 116 can detect that the requestor-users are present at the geographic location by using any position-determination mechanism(s) to detect the positions of the requestor-users' user devices (e.g., using a Global Positing System (GPS) mechanism, a hot-spot proximity mechanism, a radio tower triangulation mechanism, and so on, or any combination thereof). The monitoring system 116 then counts the number of the requestor-users who are presumed to be present at the geographic location. If this number n exceeds the prescribed threshold value t, then the monitoring system 116 provides access to the non-obscured version of the content item to all those in attendance at the location.

More generally stated, the system 102 of FIG. 2 can present a non-obscured version of a content item on condition that a group of requestor-users engage in any specified triggering action. In the case of FIG. 5, the specified activity entails activating the command feature 508, corresponding to a “let me see it!” command button. In principal example of FIG. 9, the specified activity entails appearing at a predetermined location with a user device. In the latter case, a requestor-user can be said to make a valid request to obtain a non-obscured version of a content item by actually showing up at the predetermined location.

FIG. 9 also lists a few other possible instructions that can be provided to requestor-users. Each such instruction specifies a different triggering event. For example, an instruction 910 instructs the requestor-user to fill out a survey. An instruction 912 instructs the requestor-user to purchase a product and enter a coupon code associated with the product. An instruction 914 instructs the requestor-user to click a certain link by a predetermined time. An instruction 916 instructs the requestor-user to eat a healthy food item and then register that they have done so. In each case, the instruction also informs the requestor-user that if a sufficient number of people perform the specified activity, the monitoring system 116 will reveal the obscured content. A threshold value, set by the creator-user (or some other entity), defines the number of people that are necessary to perform the activity in order to trigger the release of the non-obscured content.

In another example, an instruction may invite a requestor-user to provide a correct response to a question that has been posed. For example, the user interface presentation 902 can present an instruction (not shown) that invites the requestor-users to guess at the identity of the person in the obscured version of the content item 904. The monitoring system 116 will release the non-obscured version of the content item when a predetermined number of requestor-users (as specified by the threshold value) provide the correct answer, or, in another implementation, when a predetermined number of requestor-users provide any answer.

In some implementations, the post-creation component 124 can implement the above-described features by inviting a creator-user to provide condition information that describes the triggering event that will constitute a valid request to obtain the non-obscured version of a content item. For example, the post-creation component 124 can allow the creator-user to select a particular kind of triggering event from a drop-down menu of possible triggering events. The post-creation component 124 can then invite the creator-user to specify appropriate values associated with the selected type of triggering event. For example, a creator-user may interact with the post-creation component 124 to indicate that a valid request constitutes the requestor-user's presence at a particular location. The creator-user may then interact with the post-creation component 124 to identify the particular location, e.g., by selecting the bounds of that location on a map. In another example, a creator-user may interact with the post-creation component 124 to indicate that a valid request constitutes a correct answer to a question that is posed. The creator-user may then interact with the post-creation component 124 to specify the question, along with its correct answer. Generally, the post-creation component 124 can use any user interface technique to receive the condition information described above, such as by using a wizard-type user interface technique. In another implementation, the post-creation component 124 can allow a creator-user to craft condition information in a more open-ended manner, e.g., by specifying an IF-THEN rule.

The monitoring system 116 can store the condition information and the threshold value specified by the creator-user in the data store 136. The monitoring system 116 then determines whether a sufficient number of valid requests have been received. What constitutes a valid request is defined by the condition information. What constitutes a sufficient number of requests is defined by the threshold value. The threshold value can specify any number, including a single requestor-user.

In another variation, the post-creation component 124 can allow a creator-user to specify multiple zones of obscuration within a content item. For example, the post-creation component 124 can allow the creator-user to obscure multiple distinct objects within a content item, each object being associated with a respective zone. The post-creation component 124 can also allow the creator-user to select the triggering condition associated with each zone (e.g., as defined by an instance of condition information and a threshold value).

For example, a creator-user may interact with the post-creation component 124 to blur the faces of three people in a digital photo. The creator-user may then interact with the post-creation component 124 to define a triggering condition associated with each face. The triggering conditions for different zones can be the same, or may differ among zones. For example, the creator-user can specify that one hundred requestor-users are required to perform some specified action to trigger revelation of a first person's face, whereas three hundred requestor-users are required to perform some other specified action to trigger revelation of a second person's face. The creator-user can also define appropriate instructions to the requestor-users, which inform the requestor-users what actions they are expected to perform to unlock different parts of the content item. For example, consider a digital photo that contains two zones of obscuration which conceal two respective objects. One instruction may read, “Visit Tony's Pizzeria on Saturday to see the door prize in the corner of the room.” Another instruction may read, “Order a pizza from Tony's Pizzeria by Friday to see what Tony is holding in his hand.”

The monitoring system 116 can perform selective release of a content item in different ways. In one approach, the monitoring system 116 can store multiple versions of a content item. Each such version has a different combination of zones that are obscured and non-obscured. The monitoring system 116 can then provide access to an appropriate version of the content item depending on the triggering conditions that have been satisfied. In another case, the monitoring system 116 can selectively de-obfuscate each zone within the content item when the triggering condition associated with that zone has been satisfied. The monitoring system 116 can achieve this effect by reversing the obscuration associated with the zone, providing a decryption key associated with the zone, and/or via some other mechanism.

In another variation, the monitoring system 116 can provide access to a non-obscured version of a content item in a variable manner, with respect to any number of discrete gradations or a continuous range of gradations. For example, assume that a creator-user specifies that a non-obscured version of a content item is to be fully revealed when one hundred requestor-users perform some instructed triggering behavior. The monitoring system 116 may gradually remove the obscuration from the content item as a function of the number of requestor-users who have requested such access, even though the threshold value associated with full revelation has not yet been reached. For example, when twenty-five requestor-users have performed the triggering behavior, the monitoring system 116 can remove one quarter of the obscuration from the content item. When fifty requestor-users have performed the triggering behavior, the monitoring system 116 can remove a half of the obscuration, and so on. In those cases in which a content item has plural zones associated with different obscured objects, the monitoring system 116 can gradually remove the obscuration of each zone as a function of the number of valid requests that have been received that are pertinent to that zone.

The monitoring system 116 can remove the obscuration in gradations in different ways. In one approach, the monitoring system 116 can remove a pixelization effect or a blur effect from the content item as a function of a number of requestor-users who have performed the specified action, e.g., by incrementally changing a parameter value which defines the extent of the effect. In another approach, the monitoring system 116 can gradually remove a blocking mask as a function of a number of requestor-users who have performed the specified action, e.g., by incrementally shrinking the size of the mask. In another approach, the monitoring system 116 can incrementally remove the obscuration from different discrete objects in the content item as a function of a number of requestor-users who have performed the specified action, e.g., by removing the obscuration of different faces in a digital photo in an incremental fashion. In some cases, the creator-user can also explicitly specify the stages associated with the piecemeal revelation of a content item, and the triggering conditions associated with each stage.

As another variation, the system 102 can allow each commenting-user to specify a triggering condition that will cause the monitoring system 116 to remove the obscuration from that commenting-user's supplemental information item (instead of tying the revelation to the triggering condition associated with the creator-user's main posting). As another variation, the system 102 can gradually remove the obscuration associated with a supplemental information item in the manner describe above, e.g., based on a number of valid requests that have been received that pertain to the supplemental information item.

B. Illustrative Processes

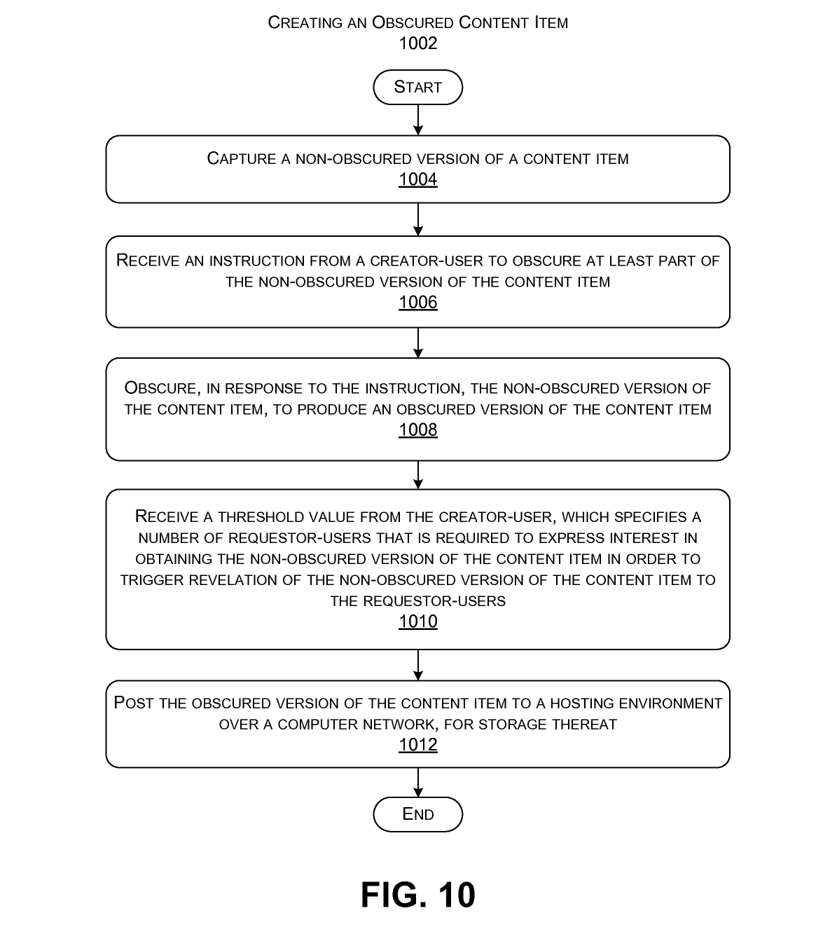

FIGS. 10-12 show processes that explain the operation of the system 102 of Section A in flowchart form. Since the principles underlying the operation of the system 102 have already been described in Section A, certain operations will be addressed in summary fashion in this section. As noted in the prefatory part of the Detailed Description, the flowcharts are expressed as a series of operations performed in a particular order. But the order of these operations is merely representative, and can be varied in any manner.

Starting with FIG. 10, this figure shows a process 1002 that represents one way of creating an obscured version of a content item, and then posting it to the hosting system 112. In the following explanation, the posting functionality 122, implemented by the user device 104, is identified as the agent which performs the process 1002. But other implementations of the system 102 can allocate the functions of the process 1002 among the components of the system 102 in any way. In block 1004, the posting functionality 122 captures a non-obscured version of a content item. In block 1006, the posting functionality 122 receives an instruction from a creator-user to obscure at least one part of the non-obscured version of the content item. In block 1008, the posting functionality 122 obscures, in response to the instruction, the non-obscured version of the content item, to produce an obscured version of the content item. In block 1010, the posting functionality 122 receives a threshold value from the creator-user, which specifies a number of requestor-users that is required to express interest in obtaining the non-obscured version of the content item in order to trigger revelation of the non-obscured version of the content item to the requestor-users. Although not shown, block 1010 may also entail receiving condition information from the creator-user, which defines what constitutes a valid request to obtain the non-obscured version of the content item. In block 1012, the posting functionality 122 posts the obscured version of the content item to a hosting environment over the computer network 120, for storage thereat.

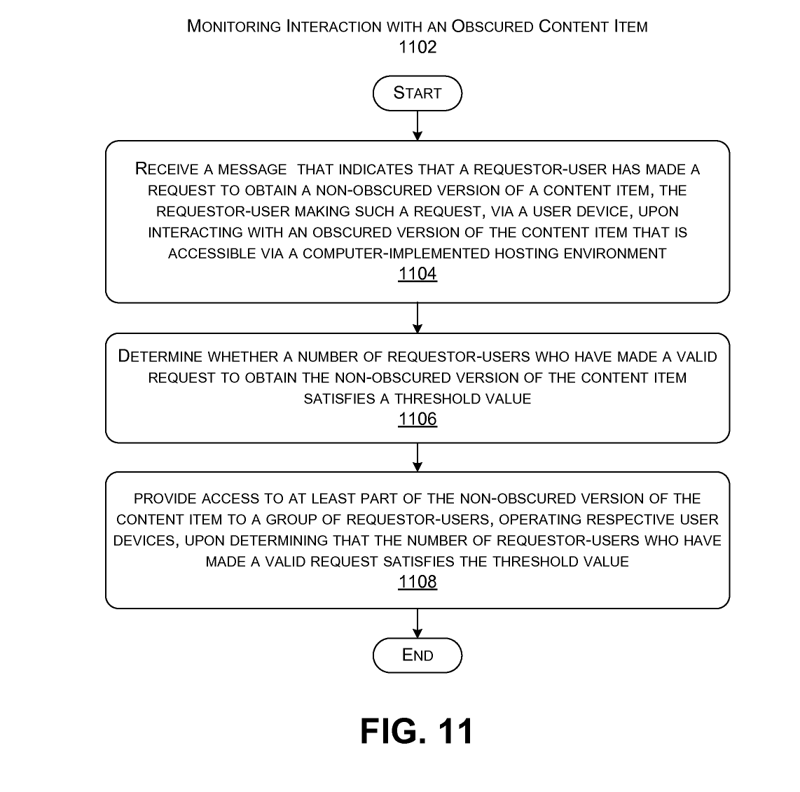

FIG. 11 shows a process 1102 that represents one way that the monitoring system 116 can monitor requests by requestor-users to receive a non-obscured version of a content item. In block 1104, the monitoring system 116 receives a message over the computer network 120 that indicates that a requestor-user has made a request to obtain a non-obscured version of a content item, the requestor-user making such a request, via a user device 106, upon interacting with an obscured version of the content item that is accessible via a computer-implemented hosting environment. In block 1106, the monitoring system 116 determines whether a number of requestor-users who have made a valid request to obtain the non-obscured version of the content item satisfies a threshold value. In block 1106, the monitoring system 116 provides access to the non-obscured version of the content item to a group of requestor-users, operating respective user devices (106, 108, . . . , 110), upon determining that the number of requestor-users who have made a valid request satisfies the threshold value.

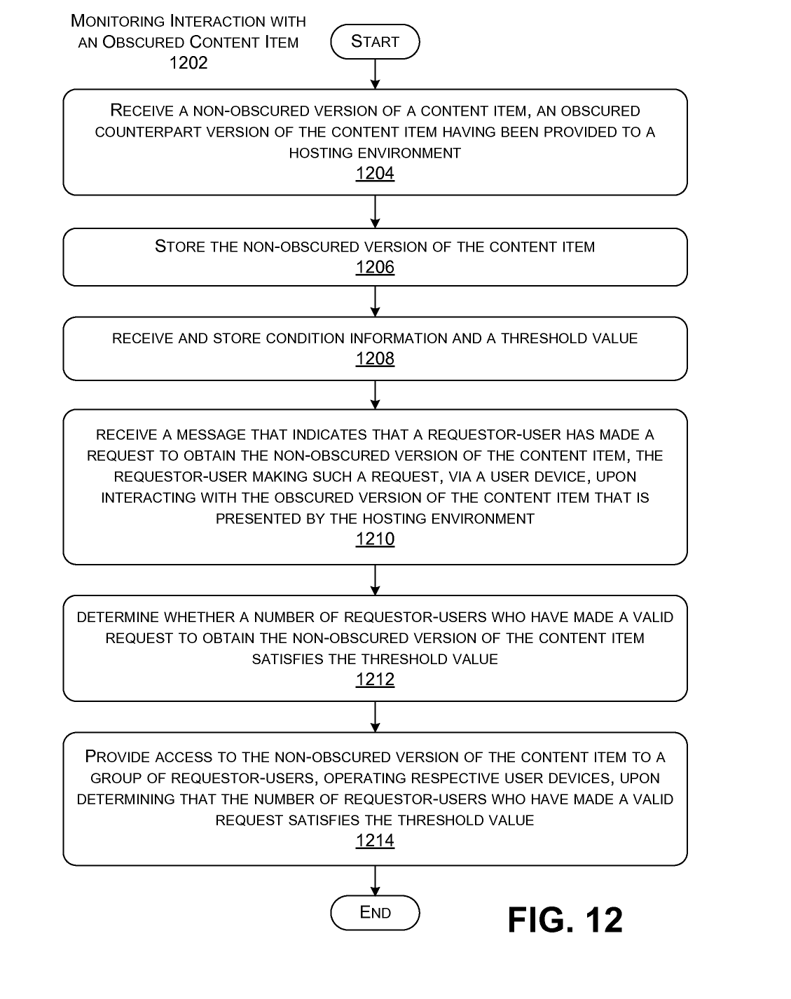

FIG. 12 shows a process 1202 which represents a more detailed instantiation of the process 1202 of FIG. 11. In block 1204, the monitoring system 116 receives, over the computer network 120, a non-obscured version of a content item, an obscured counterpart version of the content item having been provided to a hosting environment. In block 1206, the monitoring system 116 stores the non-obscured version of the content item. In block 1208, the monitoring system 116 receives and stores a threshold value, and also optionally receives and stores condition information. In block 1210, the monitoring system 116 receives a message over the computer network 120 that indicates that a requestor-user has made a request to obtain the non-obscured version of the content item, the requestor-user making such a request, via a user device 106, upon interacting with the obscured version of the content item that is presented by the hosting environment. In block 1212, the monitoring system 116 determines whether a number of requestor-users who have made a valid request to obtain the non-obscured version of the content item satisfies the threshold value. In block 1214, the monitoring system 116 provides access to the non-obscured version of the content item to a group of requestor-users, operating respective user devices (106, 108, . . . , 110), upon determining that the number of requestor-users who have made a valid request satisfies the threshold value.

C. Representative Computing Functionality

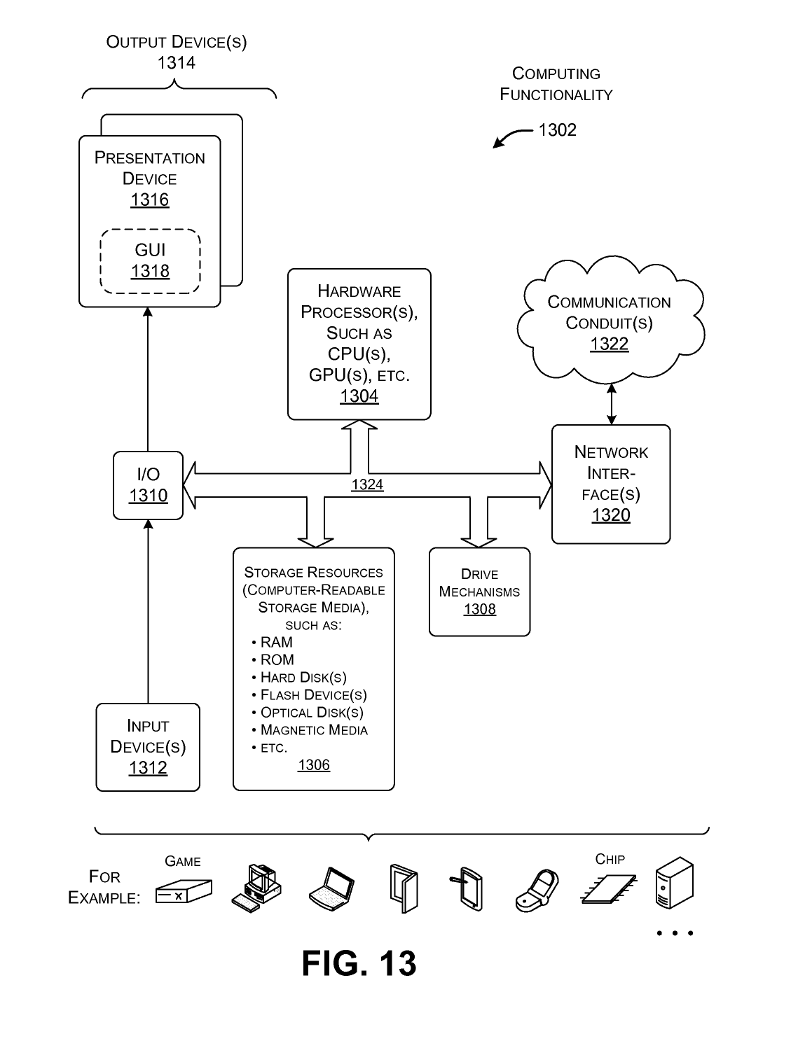

FIG. 13 shows computing functionality 1302 that can be used to implement any aspect of the system 102 set forth in the above-described figures. For instance, the type of computing functionality 1302 shown in FIG. 13 can be used to implement any of the user devices (104, 106, 108, . . . 110) shown in FIG. 1, and/or any of the systems (112, 116) shown in FIG. 1. In all cases, the computing functionality 1302 represents one or more physical and tangible processing mechanisms.

The computing functionality 1302 can include one or more hardware processors 1304, such as one or more central processing units (CPUs), and/or one or more graphical processing units (GPUs), and so on. The computing functionality 1302 can also include any storage resources (also referred to as computer-readable storage media or computer-readable storage medium devices) 1306 for storing any kind of information, such as machine-readable instructions, settings, data, etc. Without limitation, for instance, the storage resources 1306 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1302. The computing functionality 1302 may perform any of the functions described above when the hardware processor(s) 1304 carry out computer-readable instructions stored in any storage resource or combination of storage resources. The computing functionality 1302 also includes one or more drive mechanisms 1308 for interacting with any storage resource, such as a hard disk drive mechanism, an optical disk drive mechanism, and so on.

The computing functionality 1302 also includes an input/output component 1310 for receiving various inputs (via input devices 1312), and for providing various outputs (via output devices 1314). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1316 and an associated graphical user interface presentation (GUI) 1318. The presentation device 1316 may correspond to a physical monitor (e.g., a charge-coupled display device, a cathode ray tube device, a projection mechanism, etc.). Other output devices include a printer, a model-generating mechanism, a tactile output mechanism, an archival mechanism (for storing output information), and so on. The computing functionality 1302 can also include one or more network interfaces 1320 for exchanging data with other devices via one or more communication conduits 1322. One or more communication buses 1324 communicatively couple the above-described components together.

The communication conduit(s) 1322 can be implemented in any manner, e.g., by a local area computer network, a wide area computer network (e.g., the Internet), point-to-point connections, etc., or any combination thereof. The communication conduit(s) 1322 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1302 (and its hardware processor) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself.

The following summary provides a non-exhaustive list of illustrative aspects of the technology set forth herein.

According to a first aspect, a monitoring system, implemented by one or more computing devices, is described for providing access to a content item. The monitoring system includes at least one hardware processor for executing instructions to perform operations of: receiving a message over a computer network that indicates that a requestor-user has made a request to obtain a non-obscured version of a content item, the requestor-user making such a request, via a user device, upon interacting with an obscured version of the content item that is accessible via a computer-implemented hosting environment; determining whether a number of requestor-users who have made a valid request to obtain the non-obscured version of the content item satisfies a threshold value; and providing access to at least part of the non-obscured version of the content item to a group of requestor-users, operating respective user devices, upon determining that the number of requestor-users who have made a valid request satisfies the threshold value.

According to a second aspect, the operations further include: receiving the non-obscured version of the content item from a creator-user who has created the obscured version of the content item; storing the non-obscured version of the original content item in a data store; receiving condition information from the creator-user which defines what constitutes a valid request; storing the condition information; receiving the threshold value from the creator-user; and storing the threshold value.

According to a third aspect, the hosting environment corresponds to a computer-implemented hosting system which provides the obscured version of the content item to the requestor user in an information feed.

According to a fourth aspect, a valid request by the requestor-user indicates that the requestor-user has activated a graphical command feature and/or performed a prescribed command gesture.

According to a fifth aspect, a valid request by the requestor-user indicates that a user device associated with the requestor-user is present in an identified geographic location, as determined based on location information provided by a position-determination mechanism.

According to a sixth aspect, a valid request by the requestor-user indicates that the requestor-user has provided a correct answer to a question that has been posed.

According to a seventh aspect, prior to the threshold value being satisfied, the above-referenced providing access entails providing access to a portion of the non-obscured version of the content item that depends in extent on the number of requestor-users who have made a valid request.

According to an eighth aspect, the obscured version of the content item includes plural zones. Further, the above-referenced providing access entails providing selective access to a non-obscured counterpart of a zone when a number of valid requests associated with that zone satisfies a threshold value associated with that zone.

According to a ninth aspect, the above-referenced providing access entails sending the above-referenced at least part of the non-obscured version of the content item to each of the requestor-users in the group of requestor-users.

According to a tenth aspect, the above-referenced providing access entails providing a decryption key to each of the requestor-users in the group of requestor-users, which enables the requestor-users to obtain the above-referenced at least part of the non-obscured version of the content item.

According to an eleventh aspect, the obscured version of the content item, as presented by the hosting environment, is also associated with one or more supplemental information items that have been posted by one or more respective commenting-users, other than a creator-user who produces the obscured version of the content item. Further, at least one supplemental information item, among the above-referenced one or more supplemental information items, is at least partially obscured, by instruction of a corresponding commenting-user who produces the above-referenced at least one supplemental information item.

According to a twelfth aspect, at least one supplemental information item is a text-bearing post.

According to a thirteenth aspect, the above-referenced providing access also includes providing access to a non-obscured version of the above-referenced at least one supplemental information item, along with the non-obscured version of the content item, to each of the requestor-users.

According to a fourteenth aspect, at least one computing device is described for posting a content item. The device(s) include at least one hardware processor for executing instructions to perform operations of: capturing a non-obscured version of a content item; receiving an instruction from a creator-user to obscure at least part of the non-obscured version of the content item; obscuring, in response to the instruction, the non-obscured version of content item, to produce an obscured version of the content item; receiving a threshold value from the creator-user, which specifies a number of requestor-users that is required to express interest in obtaining the non-obscured version of the content item in order to trigger revelation of at least part of the non-obscured version of the content item to the requestor-users; and posting the obscured version of the content item to a hosting environment over a computer network, for storage thereat.

According to a fifteenth aspect, the operations further include receiving condition information from the creator-user which defines what constitutes a valid request from a requestor-user.

According to a sixteenth aspect, the above-referenced receiving an instruction from a creator-user includes receiving an instruction from the creator-user to obscure plural zones of the non-obscured version of the content item. Further, the above-referenced receiving a threshold value from the creator-user comprises receiving plural threshold values associated with the respective zones.

According to a seventeenth aspect, the above-referenced receiving an instruction to obscure comprises receiving a specification, by the creator-user, of at least one object to be obscured in the non-obscured version of the content item. Further, the above-referenced obscuring includes automatically recognizing the above-referenced at least one object and then obscuring the above-referenced at least one object in the non-obscured version of the content item.

According an eighteenth aspect, a method, implemented by one or more computing devices, is described for providing access to a content item. The method includes: receiving, over a computer network, a non-obscured version of a content item, an obscured counterpart version of the content item having been provided to a hosting environment; storing the non-obscured version of the content item in a data store; receiving a threshold value over the computer network; storing the threshold value; receiving condition information which describes what constitutes a valid request; storing the condition information; receiving a message over the computer network that indicates that a requestor-user has made a request to obtain the non-obscured version of the content item, the requestor-user making such a request, via a user device, upon interacting with the obscured version of the content item that is presented by the hosting environment; determining whether a number of requestor-users who have made a valid request to obtain the non-obscured version of the content item satisfies the threshold value; and providing access to at least part of the non-obscured version of the content item to a group of requestor-users, operating respective user devices, upon determining that the number of requestor-users who have made a valid request satisfies the threshold value.

According to a nineteenth aspect, a valid request by the requestor-user, as specified by the condition information, indicates that the requestor-user has activated the command feature and/or performed a prescribed command gesture.

According to a twentieth aspect, a valid request by the requestor-user, as specified by the condition information, indicates that the user device, carried by the requestor-user, is present at an identified geographic location.

A twenty-first aspect corresponds to any combination (e.g., any permutation or subset) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

This description may have described various concepts in the context of illustrative challenges or problems. This manner of explanation does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A monitoring system, implemented by one or more computing devices, for providing access to a content item, comprising:
at least one hardware processor for executing instructions to perform operations of:
receiving a message over a computer network that indicates that a requestor-user has made a request to obtain a non-obscured version of a content item, the requestor-user making such a request, via a user device, upon interacting with an obscured version of the content item that is accessible via a computer-implemented hosting environment;
determining whether a number of requestor-users who have made a valid request to obtain the non-obscured version of the content item satisfies a threshold value; and
providing access to at least part of the non-obscured version of the content item to a group of requestor-users, operating respective user devices, upon determining that the number of requestor-users who have made a valid request satisfies the threshold value.

2. The monitoring system of claim 1, further comprising:
receiving the non-obscured version of the content item from a creator-user who has created the obscured version of the content item;
storing the non-obscured version of the original content item in a data store;
receiving condition information from the creator-user which defines what constitutes a valid request;
storing the condition information;
receiving the threshold value from the creator-user; and
storing the threshold value.

3. The monitoring system of claim 1, wherein the hosting environment corresponds to a computer-implemented hosting system which provides the obscured version of the content item to the requestor user in an information feed.

4. The monitoring system of claim 1, wherein a valid request by the requestor-user indicates that the requestor-user has activated a graphical command feature and/or performed a prescribed command gesture.

5. The monitoring system of claim 1, wherein a valid request by the requestor-user indicates that the user device associated with the requestor-user is present in an identified geographic location, as determined based on location information provided by a position-determination mechanism.

6. The monitoring system of claim 1, wherein a valid request by the requestor-user indicates that the requestor-user has provided a correct answer to a question that has been posed.

7. The monitoring system of claim 1, wherein, prior to the threshold value being satisfied, said providing access entails providing access to a portion of the non-obscured version of the content item that depends in extent on the number of requestor-users who have made a valid request.

8. The monitoring system of claim 1,
wherein the obscured version of the content item includes plural zones, and
wherein said providing access entails providing selective access to a non-obscured counterpart of a zone when a number of valid requests associated with that zone satisfies a threshold value associated with that zone.

9. The monitoring system of claim 1, wherein said providing access entails sending said at least part of the non-obscured version of the content item to each of the requestor-users in the group of requestor-users.

10. The monitoring system of claim 1, wherein said providing access entails providing a decryption key to each of the requestor-users in the group of requestor-users, which enables the requestor-users to obtain said at least part of the non-obscured version of the content item.

11. The monitoring system of claim 1,
wherein the obscured version of the content item, as presented by the hosting environment, is also associated with one or more supplemental information items that have been posted by one or more respective commenting-users, other than a creator-user who produces the obscured version of the content item, and
wherein at least one supplemental information item, among said one or more supplemental information items, is at least partially obscured, by instruction of a corresponding commenting-user who produces said at least one supplemental information item.

12. The monitoring system of claim 11, wherein at least one supplemental information item is a text-bearing post.

13. The monitoring system of claim 11, wherein said providing access also comprises providing access to a non-obscured version of said at least one supplemental information item, along with the non-obscured version of the content item, to each of the requestor-users.

14. One or more computing devices for posting a content item, comprising:
at least one hardware processor for executing instructions to perform operations of:
capturing a non-obscured version of a content item;
receiving an instruction from a creator-user to obscure at least part of the non-obscured version of the content item;
obscuring, in response to the instruction, the non-obscured version of content item, to produce an obscured version of the content item;
receiving a threshold value from the creator-user, which specifies a number of requestor-users that is required to express interest in obtaining the non-obscured version of the content item in order to trigger revelation of at least part of the non-obscured version of the content item to the requestor-users; and
posting the obscured version of the content item to a hosting environment over a computer network, for storage thereat.

15. The one or more computing devices of claim 14, further comprising receiving condition information from the creator-user which defines what constitutes a valid request from a requestor-user.

16. The one or more computing devices of claim 14,
wherein said receiving an instruction from a creator-user comprises receiving an instruction from the creator-user to obscure plural zones of the non-obscured version of the content item, and
wherein said receiving a threshold value from the creator-user comprises receiving plural threshold values associated with the respective zones.

17. The one or more computing devices of claim 14, wherein said receiving an instruction to obscure comprises receiving a specification, by the creator-user, of at least one object to be obscured in the non-obscured version of the content item, and
wherein said obscuring comprises automatically recognizing said at least one object and then obscuring said at least one object in the non-obscured version of the content item.

18. A method, implemented by one or more computing devices, for providing access to a content item, comprising:
receiving, over a computer network, a non-obscured version of a content item, an obscured counterpart version of the content item having been provided to a hosting environment;
storing the non-obscured version of the content item in a data store;
receiving a threshold value over the computer network;
storing the threshold value;
receiving condition information which describes what constitutes a valid request;
storing the condition information;
receiving a message over the computer network that indicates that a requestor-user has made a request to obtain the non-obscured version of the content item, the requestor-user making such a request, via a user device, upon interacting with the obscured version of the content item that is presented by the hosting environment;
determining whether a number of requestor-users who have made a valid request to obtain the non-obscured version of the content item satisfies the threshold value; and
providing access to at least part of the non-obscured version of the content item to a group of requestor-users, operating respective user devices, upon determining that the number of requestor-users who have made a valid request satisfies the threshold value.

19. The method of claim 18, wherein a valid request by the requestor-user, as specified by the condition information, indicates that the requestor-user has activated the command feature and/or performed a prescribed command gesture.

20. The method of claim 18, wherein a valid request by the requestor-user, as specified by the condition information, indicates that the user device, carried by the requestor-user, is present at an identified geographic location.
